(19) United States
(12) Patent Application Publication
(10) Pub. No.: US 2026/0220457 A1
(43) Pub. Date: Jul. 30, 2026

(54) f-DIVERGENCE MINIMIZATION FOR ONE STEP DIFFUSION MODELS

(71) Applicant: NVIDIA Corporation, Santa Clara, CA (US)

(72) Inventors: Yilun Xu, Santa Clara, CA (US); Weili Nie, Sunnyvale, CA (US); Arash Vahdat, San Mateo, CA (US)

(21) Appl. No.: 19/455,565

(22) Filed: Jan. 21, 2026

Related U.S. Application Data
(60) Provisional application No. 63/751,548, filed on Jan. 30, 2025.

(51) Int. Cl. G06N 3/08; G06N 3/0475

(52) U.S. Cl. CPC G06N 3/08; G06N 3/0475

(57) ABSTRACT

ƒ-distill is a framework for distributional matching distillation based on ƒ-divergence minimization. A student diffusion model (DM) can be trained by generating an output content, scoring a student distribution of data values, and then comparing the student scores to a teacher DM scoring. The scoring process can use a gradient algorithm that scores multiple regions of the generated content individually. The gradient algorithm can comprise the product of the weighting function and the score difference between the teacher and student distributions across each region of the generated content. Each region's score can be weighted separately from other regions based on data distributions, mode-seeking parameters, or other factors. ƒ-distill can encompass variational score distillation objectives while allowing less mode-seeking divergences. In some aspects, by leveraging the weighting function, ƒ-distill can down weight regions with larger score estimation errors.

### CROSS-REFERENCE

This application claims the benefit of U.S. Provisional Application Ser. No. 63/751,548, filed by Yilun Xu, et al., on Jan. 30, 2025, entitled “SYSTEM AND METHOD FOR ONE STEP DIFFUSION MODELS WITH f-DIVERGENCE DISTRIBUTION MATCHING,” commonly assigned with this application and incorporated herein by reference in its entirety.

### TECHNICAL FIELD

This application is directed, in general, to machine learning models and, more specifically, to large-scale diffusion models.

### BACKGROUND

Text-to-image (T2I) and text-to-video (T2V) models are machine learning (ML) models that generate images or videos based on an input text description. T2I and T2V diffusion models are examples of ML models that use a text description and generate an image or video using a diffusion process. T2I and T2V diffusion models have a neural network architecture that is configured to generate data similar to the training data that is used for training. The training data includes reference images or reference motion videos that are provided to a T2I or T2V diffusion model for learning.

### BRIEF DESCRIPTION

Reference is now made to the following descriptions taken in conjunction with the accompanying drawings, in which:

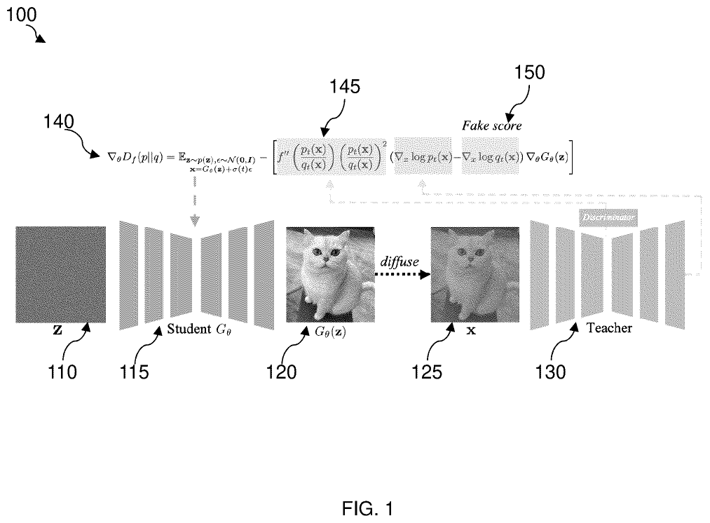

FIG. 1 is an illustration of a diagram of an example ƒ-distill model;

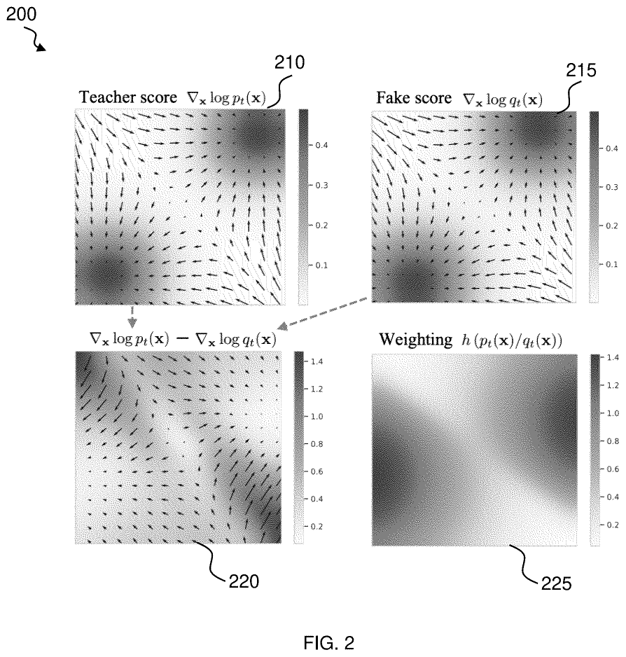

FIG. 2 is an illustration of a diagram of an example score difference;

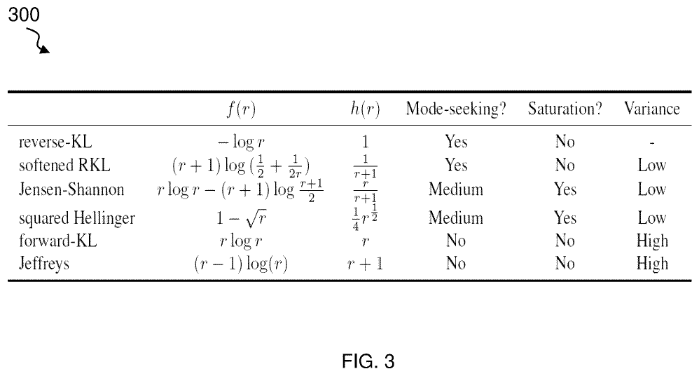

FIG. 3 is an illustration of a diagram of an example table comparing ƒ-divergence models;

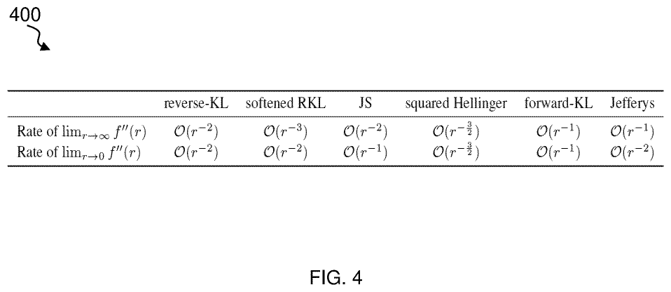

FIG. 4 is an illustration of a diagram of an example table comparing right and left tail weightings;

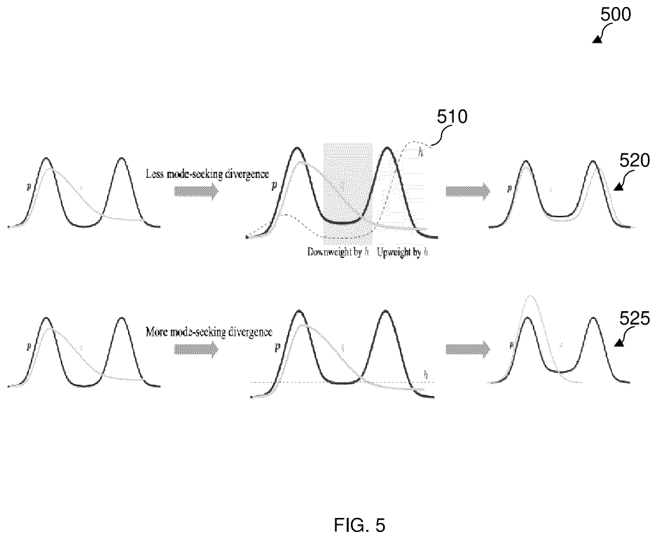

FIG. 5 is an illustration of a diagram of example charts demonstrating a weighting function with mode-seeking divergence;

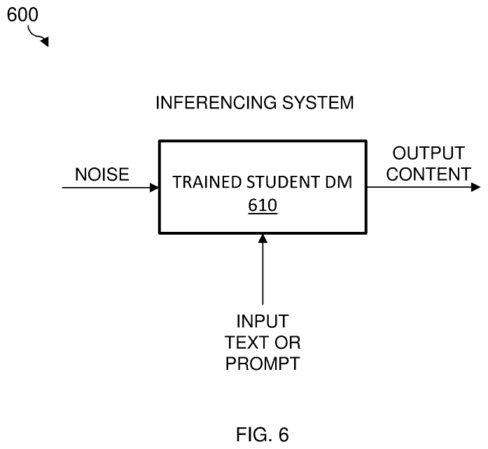

FIG. 6 is an illustration of a diagram of an example inferencing system;

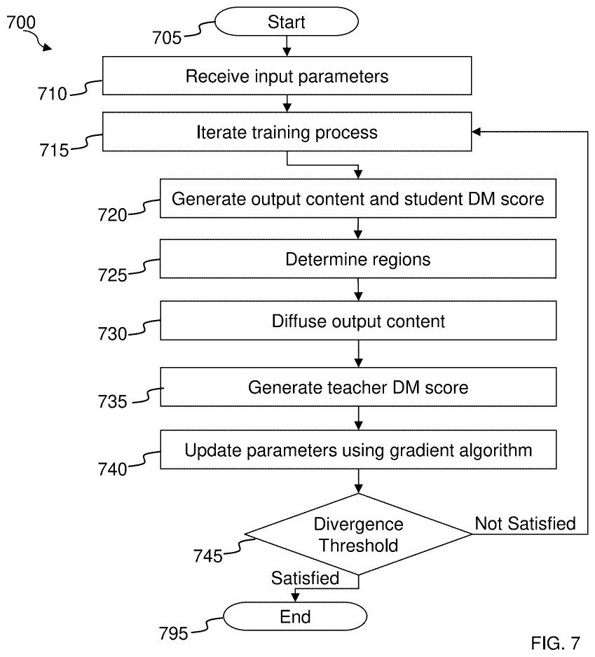

FIG. 7 is an illustration of a flow diagram of an example method for implementing the ƒ-distill model;

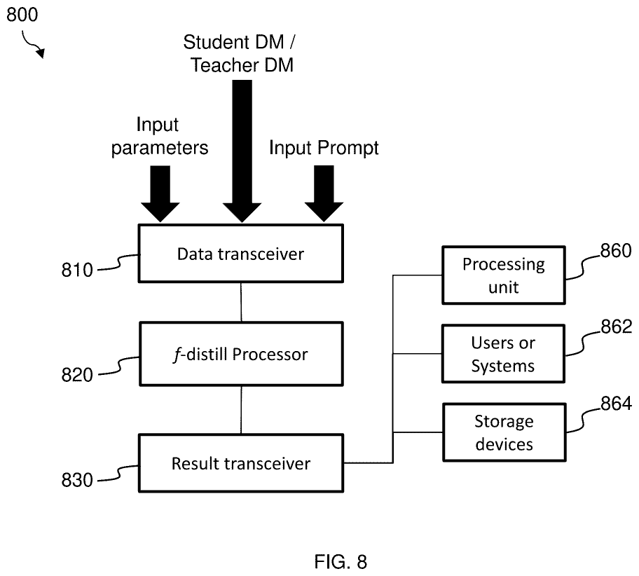

FIG. 8 is an illustration of a block diagram of an example ƒ-distill system; and

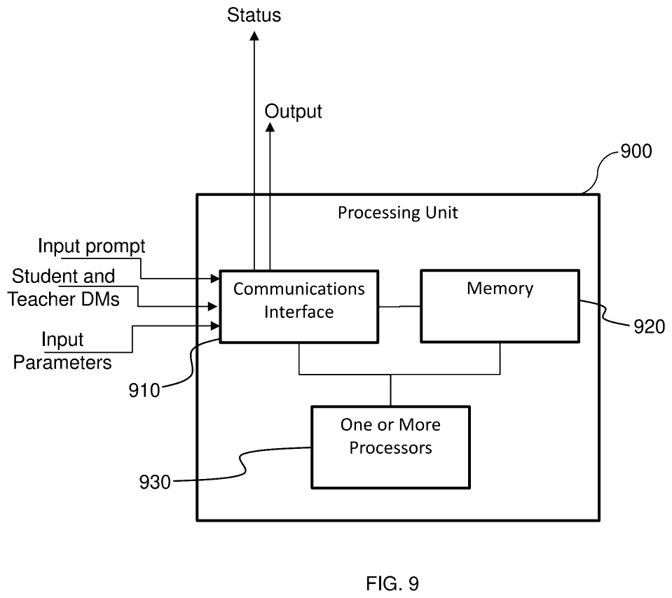

FIG. 9 is an illustration of a block diagram of an example of a ƒ-distill controller according to the principles of the disclosure.

### DETAILED DESCRIPTION

Diffusion models are transforming generative modeling in visual domains, with impressive success in generating images, videos, three-dimensional (3D) objects, motion, or other visual media or forms. One limitation of deploying diffusion models in real-world applications is their slow and computationally expensive sampling process that involves calling the denoising neural network iteratively. The denoising neural network can have function calls that gradually generate a clean image or images (still or moving images, e.g., video). The slow iterative process of sampling from diffusion models can hinder the practical deployment, especially for interactive applications

Conventional processes for accelerating diffusion models relied on better numerical solvers for solving the ordinary differential equations (ODEs) or stochastic differential equations (SDEs) that describe the sampling process of diffusion models. These methods can reduce the number of sampling steps to around tens of steps, due to the discretization error.

More recently, distillation-based approaches aim at reducing the number of sampling steps to a single network call. These approaches can be generally grouped into two categories: 1) trajectory distillation which distills the deterministic ODE mapping between noise and data intrinsic in a diffusion model to a one-step student, and 2) distribution matching approaches that ignore the deterministic mappings, and instead, matches the distribution of samples generated by a one-step student to the distribution imposed by a pre-trained teacher diffusion model. Among the two categories, the latter often performs better in practice as the deterministic mapping between noise and data is deemed complex and hard to learn. The choice of divergence in distribution matching plays a role in how the student's distribution is matched against the teacher's. Existing works often use variational score distillation that matches the distribution of the student and teacher by minimizing the reverse Kullback-Leibler (KL) divergence. This divergence can be mode-seeking and can potentially ignore diverse modes learned by the diffusion model.

This disclosure presents processes for a generalization of the distribution matching distillation approach using the ƒ-divergence model, termed ƒ-distill. The ƒ-divergence represents a large family of divergences, including reverse-KL, forward-KL, Jensen-Shannon (JS), squared Hellinger, and other divergence models. These divergences can come with different trade-offs on how they penalize the student for missing modes in the teacher distribution and how they can be estimated and optimized using Monte Carlo sampling. Within the disclosed framework, various ƒ-divergences can be evaluated based on these properties and different tradeoffs observed. For instance, forward-KL can have a better mode coverage, while having a large gradient variance; JS can demonstrate moderate mode-seeking and gradient saturation, particularly in early training stages, while exhibiting low variance. No ƒ-divergence model can consistently outperform other models across various datasets. Divergences with better mode coverage tendencies can generally perform better on the CIFAR-10 dataset. On large-scale challenging datasets like ImageNet-64 and text-to-image generation with Stable Diffusion (SD), divergences with lower variance can achieve better results.

This disclosure of the ƒ-divergence distribution matching processes can show that the gradient of the objectives is the product of the difference in score between teacher and student, and a weighting function that depends on the density ratio and the chosen ƒ-divergence. The density ratio can be obtained from the discriminator objective, such as in the auxiliary generative adversarial networks (GAN) objective. The weighting function utilizes variable weighting, and not a constant weighting. The derived weighting coefficient influences the trade-offs of the various ƒ-divergence models, and normalization techniques can be used for stabilizing divergences with higher gradient variance. The weight coefficient for ƒ-divergences with less mode-seeking tendency can down-weight the score difference in the areas where the teacher has a low density of data values. This can align with score estimations in low-density regions that can be inaccurate, and can allow the disclosed ƒ-distill model to adaptively rely less on matching its score with the teacher's unreliable score on such regions.

Quantitative results from experimentation can demonstrate that the less mode-seeking divergences in ƒ-distill can outperform previous variational score distillation approaches. By minimizing the less mode-seeking and lower gradient variance Jensen-Shannon divergences, ƒ-distill can achieve improved one-step generation performance on ImageNet-64 and zero-shot MS-COCO. The weighting function can effectively assign smaller weights to regions with larger score differences.

The disclosed process, i.e., the ƒ-distill model, can generalize distribution matching distillation using ƒ-divergence, allowing flexibility in how the student distribution is matched against the teacher's distribution. There can be different trade-offs with different choices of ƒ-divergence in terms of mode seeking, gradient saturation, and variance. Guidelines can be provided on reducing the variance of the gradient and estimating different terms in the objective.

The disclosed ƒ-distill can be used to accelerate the generation of pre-trained (continuous-time) diffusion models (DMs). In this disclosure, the efficient diffusion model (EDM) framework can be used for the notations and forward/backward processes. DMs can perturb the clean data x₀~p_{data} in a fixed forward process using σ²(t)-variance Gaussian noise, where x₀∈ [symbol] ^{d}, and t denotes the time along the diffusion process. The resulting intermediate distribution can be denoted as pₜ(xₜ) with xₜ∈ [symbol] ^{d}. For notation simplicity, x can be used to replace xₜ, unless stated otherwise, throughout this disclosure. For sufficiently large σₘₐₓ, this distribution can be almost identical to pure random Gaussian noise. DMs leverage this observation to sample the initial noise

$${∈}_{max} ∼ N ( 0 , {σ}_{max}^{2} I ) ,$$

and then iteratively denoise the sample by solving the following backward ODE/SDE, which guarantees that if σ(0)=0, the final x can follow the data distribution p_{data}, as shown in Equation 1.

$$\begin{matrix}Example data distribution & \\ dx = - σ ( t ) σ ( t ) {∇}_{x} \dot{l} og {p}_{t} ( x ) dt \} Probability flow ODE \\ - β ( t ) {σ}^{2} ( t ) {∇}_{x} log {p}_{t} ( x ) d t + \sqrt{2 β ( t )} σ ( t ) d {ω}_{t} \} Langevin diffusion SDE & Equation 1\end{matrix}$$

where ωₜ is a standard Wiener process, and
∇ₓ log pₜ(x) is the score function of the intermediate distribution pₜ(x).

The score function can be learned by a neural network s_{φ}(x; σ(t)) trained with the denoising score matching objective. In Equation 1, the first term is the Probability Flow ODE, which can guide samples from high to low noise levels. The second term is a Langevin Diffusion SDE, which can act as an equilibrium sampler across different noise levels σ(t), effectively refining the samples and correcting errors during the sampling process. This component can be scaled by the time-dependent parameter β(t). Setting β(t)=0 can lead to ODE-based synthesis. Solving the diffusion ODE and SDE can involve a significant number of iterations (e.g., tens or hundreds of iterations), posing a computational and timing challenge to the practical deployment of diffusion models. Conventional accelerated samplers for diffusion ODE and SDE have been used, but they can require more than 20 sampling steps in practice to produce decent samples.

Teacher diffusion models s_{φ} can be distilled into a single-step generator Go, through variational score distillation (VSD), which can be used for test-time optimization of 3D objects. The teacher diffusion step can enable a student model G_{θ} to directly map the noise z from the prior distribution p(z)=N(z; 0, I) to the clean sample x₀ at σ=0 using x₀=G_{θ}(z), effectively bypassing the iterative sampling process. Let p_{φ} denote the distribution obtained by plugging in pre-trained diffusion models s_{φ}(x; σ(t)) in Equation 1, and let q_{θ} denote the output distribution by the one-step generator G_{θ} (in the following text, we drop the subscript in p_{φ} and q_{θ} for notation simplicity). Then, the gradient update for the generator can be formulated as shown in Equation 2.

$$\begin{matrix}Example gradient update for a generator & \\ {𝔼}_{t , z , ϵ} [ ( {s}_{ϕ} ( x ; σ ( t ) ) - {∇}_{x} log {q}_{θ} ( x ; σ ( t ) ) ) {∇}_{θ} {G}_{θ} ( z ) ] where x = {G}_{θ} ( z ) + σ ( t ) ϵ , and ϵ ∼ N ( 0 , I ) . & Equation 2\end{matrix}$$

The gradient encourages the generator to produce samples that lie within high-density regions of the data distribution. This can be achieved through the teacher score term, s_{φ}(x; σ(t)), which guides the generated samples towards areas where the teacher model assigns high probability. To prevent mode collapse, the gradient also incorporates a term that discourages the generator from simply concentrating on a single high-density point in the teacher's distribution. This is done by subtracting the score of the student distribution, ∇ₓ log q_{θ}(x;σ(t)). The gradient update is shown to perform distribution matching by minimizing the reverse-KL divergence between the teacher and student distributions.

To estimate the score of the student distribution, previous works have employed a fake score network s_{Ψ}(x, σ(t)) to approximate ∇ₓ log q_{θ}(x;σ(t)). The fake score network s_{Ψ}(x, σ(t)) can be dynamically updated with the standard denoising score matching loss, where the “clean” samples come from the generator G_{θ} during training. Thus, the VSD training alternates between the generator update and the fake score update, with a two-time-scale update rule for stabilized training. To further close the gap between the one-step generator and the multi-step teacher diffusion model, a GAN loss can be applied to the VSD training pipeline, where a lightweight GAN classifier takes as input the middle features from the fake score network.

In probability theory, an ƒ-divergence quantifies the difference between two probability density functions, p and q. Specifically, when p is absolutely continuous with respect to q, the ƒ-divergence is defined as

$${D}_{f} = ( p \vert \vert q ) = \int q ( x ) f ( \frac{p ( x )}{q ( x )} ) dx$$

where ƒ is a convex function on (0, +∞) satisfying ƒ(1)=0. This divergence can satisfy various properties, including non-negativity and the data processing inequality. Many conventional divergences can be expressed as special cases of the ƒ-divergence by choosing an appropriate function ƒ. These include the forward-KL divergence, reverse-KL divergence, Hellinger distance, and Jensen-Shannon (JS) divergence, as shown in FIG. 3. In generative learning, ƒ-divergence can be applied to popular generative models, such as GANs, variational autoencoders (VAEs), energy-based models, and diffusion models.

The disclosed processes, e.g., ƒ-distill, can minimize the ƒ-divergence between the teacher and student distributions. Since the student distribution q is the push-forward measure induced by the one-step generator G_{θ}, it implicitly depends on the generator's parameters θ. Due to this implicit dependency, directly calculating the gradient of the ƒ-divergence, D_{ƒ}(p∥q), with respect to θ can be challenging. The following establishes an analytical expression for this gradient, revealing that the gradient can be formulated as a weighted version of the gradient employed in variational score distillation. These weights can be determined by the density ratio of the generated samples. The algorithm can be generalized by providing the gradient for pₜ and qₜ, where pₜ is the perturbed distribution through the diffusion forward process for the teacher's distribution p, i.e., pₜ=p₀*N(0, σ²(t)I) (and the same for the student distribution q).

For example, let p be the teacher's generative distribution, and let q be a distribution induced by transforming a prior distribution p(z) through the differentiable mapping G_{θ}. Assuming ƒ is twice continuously differentiable, then the gradient of the ƒ-divergence between the two intermediate distributions pₜ and qₜ with respect to θ can be shown, for example, in Equation 3.

$$Example gradient of f - divergence between {p}_{t} and {q}_{t}$$

$${∇}_{θ} {D}_{f} ( {p}_{t} \vert \vert {q}_{t} ) = {𝔼}_{z , ϵ} - [ {f}^{″} ( \frac{{p}_{t} ( x )}{{q}_{t} ( x )} ) {( \frac{{p}_{t} ( x )}{{q}_{t} ( x )} )}^{2} ( {∇}_{x} log {p}_{t} ( x ) - {∇}_{x} log {q}_{t} ( x ) ) {∇}_{θ} {G}_{θ} ( z ) ] where {∇}_{x} log {p}_{t} ( x ) is the teacher score , {∇}_{x} log {q}_{t} ( x ) is the fake score , z ∼ p ( z ) , ϵ ∼ N ( 0 , I ) , and x = {G}_{θ} ( z ) + σ ( t ) ϵ \qquad Equation 3$$

Although the student's generative distribution q depends on the parameter θ, Equation 3 provides an analytical expression for the gradient of ƒ-divergences between the teachers' and students' generative distributions. This gradient is expressed as the score difference between the teacher's and student's distributions, weighted by a time-dependent factor ƒ″(pₜ(xₜ)/qₜ(xₜ)) (pₜ(xₜ)/qₜ(xₜ))² determined by both the chosen ƒ-divergence and the density ratio. Every term in the algorithm can be tractable, enabling the optimization of distributional matching through general ƒ-divergence minimization. For notation convenience, let h(r):=ƒ″(r)r² denote the weighting function, and rₜ(x):=pₜ(x)/qₜ(x) denote the density-ratio at time t. The gradient of the variational score distillation, Equation 2, can be recovered as a special case of ƒ-distill by setting h(r)=1 in Equation 3, which corresponds to minimizing the reverse-KL divergence, e.g., ƒ(r)=−log r).

There is a conventional connection between ƒ-divergence and score difference, expressing the former as a time integral of the squared score difference. This disclosure differs in two aspects: (1) The conventional objective's gradient necessitates computing a Jacobian-vector product, which can be computationally expensive. (2) While their ƒ-divergence is expressed as an integral of the score difference over time, ƒ-distill, D_{ƒ}(pₜ∥qₜ), depends on the weighting and score at time t. This disclosure shows that if the weighting function h is continuous and non-negative on (0, +∞), then its product with the score difference is the gradient of a certain ƒ-divergence. For example, for any function h that is continuous and non-negative on (0, +∞), the expectation [symbol] _{z,∈}−[h(rₜ(x)) (∇ₓ log pₜ(x)−∇ₓ log qₜ(x)) ∇_{θ}G_{θ}(z)] corresponds to the gradient of an ƒ-divergence. This allows the disclosed processes to use various continuous and non-negative scalar functions as h.

Conventional processes suggest performing distributional matching all the time along the diffusion process, as the teacher and student will have high discrepancy at smaller times, leading to optimization difficulties. This disclosure follows this setup and minimizes the ƒ-divergence along the time range, i.e.,

$$ℒ ( θ ) = {\int }_{0}^{T} {w}_{t} {D}_{f} ( {p}_{t} \vert \vert {q}_{t} ) d t ,$$

where wₜ is a time-dependent weight for equalizing the gradient magnitudes across times. The final objective function for ƒ-distill can be as shown in Equation 4.

$$\begin{matrix}Example objective function for f - distill & \\ {ℒ}_{f - distill} ( θ ) = {𝔼}_{t , x} [ sg ( {w}_{t} h ( {r}_{t} ( x ) ) {( ( {∇}_{x} log {p}_{t} ( x ) - {∇}_{x} log {q}_{t} ( x ) ) )}^{T} x ) ] where x = {G}_{θ} ( z ) + σ ( t ) ϵ , z ∼ p ( z ) , \\ ϵ ∼ N ( 0 , I ) , & Equation 4\end{matrix}$$

and
sg is the stop gradient.

The gradient of Equation 4 equals the time integral of the gradient of the ƒ-divergence in Equation 3. In practice, the score of student distribution ∇ₓ log qₜ(xₜ) can be approximated by a diffusion model s_{Ψ}(x, σ(t)). The variational score distillation loss can be augmented with a GAN objective to further enhance performance. This is motivated by the fact that variational score distillation relies solely on the teacher's score function and is therefore limited by the teacher's capabilities. Incorporating a GAN objective allows the student generator G_{θ} to surpass the teacher's limitations by leveraging real data to train a discriminator D_{λ}, as shown in Equation 5.

$$\begin{matrix}Example training of a discriminator & \\ {ℒ}_{G A N} ( λ ) = {𝔼}_{t , x ∼ {p}_{d a t a} , {ϵ}_{1}} [ log {D}_{λ} ( x + σ ( t ) {ϵ}_{1} ) ] + {𝔼}_{t , z , {ϵ}_{2}} [ log ( 1 - {D}_{λ} ( {G}_{θ} ( z ) + σ ( t ) {ϵ}_{2} ) ) ] where z ∼ p ( z ) , and ϵ1 , ϵ2 ∼ N ( 0 , I ) . & Equation 5\end{matrix}$$

The auxiliary GAN objective can be incorporated, which can offer the advantage of providing a readily available estimate of the density ratio r(xₜ) required by the weighting function in Equation 4. The density ratio is approximated as r(xₜ)=pₜ(x)/qₜ(x)≈p_{data,t}/qₜ(x)=D_{λ}(xₜ, t)/(1−D_{λ}(xₜ, t)). The GAN discriminator D_{λ} can provide a direct estimate of the density ratio, facilitating the computation of the weighting function.

Mode-seeking divergences, such as reverse-KL, encourage the generative distribution q to capture a subset of the modes of data distribution, and tend to avoid assigning probability mass to regions of low data density when solving min_{q} D_{ƒ}(p∥q)=∫ qf(p/q)dx. This behavior can be undesirable for generative models as it can lead to dropped modes and a loss of diversity in generated samples. This phenomenon can be observed in the variational score distillation loss used in DMD, which corresponds to minimizing the reverse-KL divergence in ƒ-distill. One way to characterize mode-seeking behavior can be by examining the limit lim_{r→∞} ƒ(r)/r. A lower growth rate of the limit indicates less mode-seeking. Both reverse-KL and JS divergences exhibit this finite limit, with JS having a slower growth rate (and thus, less mode-seeking behavior). In contrast, forward-KL has an infinite limit, echoing its mode-covering property.

Divergences with a stronger tendency towards mode-seeking can exhibit a slower rate of increase in their weighting function h(r) as r→∞. This behavior can stem from ƒ″(r)=h(r)/r² increasing more slowly, thus tolerating larger density ratios p/q (i.e., allowing q to disregard some modes in p), leading to mode-seeking behavior. For example, h in JS and forward-KL can be an increasing function, while in reverse-KL h can stay constant. As a result, the weighting function in the less mode-seeking divergence will tend to down weight samples in low-density regions of the teacher distribution.

A challenge encountered by prior generative models, such as GANs, when utilizing ƒ-divergence can be the issue of saturation. In the early stages of training, the generative and data distribution can be poorly aligned, resulting in samples from p having very low probability under q, and vice versa. Consequently, the density ratio p/q tends to be either extremely large or near zero. This poses optimization issues when divergences have small gradients at both extremes. Squared Hellinger and JS divergences have smaller gradients at the extremes. Nevertheless, in diffusion distillation, the saturation issue can be mitigated by initializing the weights of the student model with the pre-trained diffusion models.

The variance of the weighting function h in the final objective, Equation 4, is used to training stability in mini-batch training. The normalized variance Var_{q}(ƒ″(p/q)(p/q)²/ [symbol] _{q}[ƒ″(p/q)(p/q)²]) can be used to characterize the variance of different fs, ensuring scale-invariant comparison. The variance of the forward-KL divergence and the Jeffreys can increase significantly as the distance between the Gaussians grows. In contrast, the Jensen-Shannon divergence and the squared Hellinger distance remain relatively stable. This stability contributes to the improved empirical performance of the low-variance Jensen-Shannon divergence.

To address the high variance observed in weighting functions for less mode-seeking divergences, ƒ-distill uses a two-stage normalization scheme. The first stage normalizes the time-dependent density ratio rₜ, leveraging the fact that the expectation of rₜ is one, i.e., [symbol] _{qt}[rₜ]=1. To enforce this property, the time range can be discretized into bins and then normalize the values of rₜ within each bin by their average. The second stage can directly normalize the weighting function h by its average value within each mini-batch. This normalization can be important because the training process involves both the ƒ-distill objective and the GAN objective. The normalization ensures scale-invariance for the weightings, as the scale can vary significantly for different fs. The normalization can maintain the relative importance of the ƒ-distill objective with respect to the GAN objective, providing stability and consistency across different choices of ƒ-divergence. For example, the loss exhibits a much smaller variance after the normalization techniques are applied on ImageNet-64 using the forward-KL divergence.

In some aspects, mode-seeking can refer to the tendency of fitted generative models to capture only a subset of the dominant modes in the data distribution. This occurs during the minimization of the ƒ-divergence min_{q} D_{ƒ}(p∥q) between the true data distribution (p) and the learned generative distribution (q). An ƒ-divergence can be considered mode-seeking if its minimization leads to this mode-seeking behavior in the corresponding generative model. The mode-seeking behavior in generative models can translate into a lack of diversity. Previous classifications of mode-seeking divergences can be based on empirical observations. For example, reverse-KL can be widely considered mode-seeking, and forward-KL aims for the opposite (i.e., mode-coverage). In this disclosure, ƒ-distill can be applied to roughly classify the ƒ-divergence based on mode-seeking. A smaller limit indicates a higher tolerance of the corresponding ƒ-divergence for large density ratios (r=p/q). This allows the generative distribution q to assign less probability mass to regions where the true distribution p has low density without incurring a significant penalty. Consequently, this behavior can lead to mode-seeking, where the model focuses on capturing the dominant modes of the data distribution. Hence, the rate of the limit can be used to classify divergence in the mode-seeking column in FIG. 3.

In some aspects, mode-seeking divergence can be based on the increasing rate of the limits limᵣ→∞ ƒ″(r) and limᵣ→0 ƒ″(r), through a concept of “tail weight”. The tail weight associated with limᵣ→∞ ƒ″(r) (right tail weight)/limᵣ→0 ƒ″(r) (left tail weight) describes how strongly the mode-seeking/mode-coverage behavior can be penalized. A larger rate of limit can be translated into a higher penalty on mode-seeking. FIG. 4 demonstrates tail weights for different divergences. In general, less mode-seeking divergence will have a larger right tail weight (rate of limᵣ→∞ ƒ″(r) and smaller left tail weight (rate of limᵣ→0 ƒ″(r)). As a result, when using these canonical ƒ-divergences, the weighting function h(r) would be an increasing function if the divergence is less mode-seeking since h(r)=ƒ″(r)r². For example, h in JS and forward-KL is an increasing function, while in reverse-KL, h stays constant. An increasing h tends to down weight regions with lower density in the true data distribution p. This corresponds to regions where the teacher score is less reliable.

While ƒ-divergence-based distillation methods can match the probability density functions pₜ (teacher distribution) and qₜ (student distribution), Fisher divergence-based distillation can aim to match the distributions by minimizing the distance between their score functions. This equates to matching the gradients of the log probability density functions, ∇ₓ log pₜ(x) and ∇ₓ log qₜ(x), as shown in Equation 6.

$$\begin{matrix}Example matching gradients of log probability densities & \\ ( f - divergence ) : \begin{matrix}min \\ {q}_{t}\end{matrix} \int {q}_{t} ( x ) f ( \frac{{p}_{t} ( x )}{{q}_{t} ( x )} ) dx \\ ( General FIsher divergence ) : \begin{matrix}min \\ {q}_{t}\end{matrix} \int {q}_{t} ( x ) d ( {∇}_{x} log {p}_{t} ( x ) , {∇}_{x} log {q}_{t} ( x ) ) dx & Equation 6\end{matrix}$$

where dis a scalar-valued proper distance function satisfying d(x)≥0 and d(x)=0 if and only if x=0. When dis squared [symbol] ₂ distance, then Equation 6 reduces to Fisher divergence.

Directly minimizing the Fisher divergence in Equation 6 can be difficult. Existing works can rely on certain assumptions and approximations to make this optimization tractable. For example, in some aspects, the stop gradient operation is imposed on the sampling distribution qₜ (first term in the integral in Equation 6). They can use a Monte-Carlo sampler, derived from Tweedie's Formula, to estimate an intractable term in the gradient.

Turning now to the figures, FIG. 1 is an illustration of a diagram of an example ƒ-distill model 100. ƒ-distill model 100 is a model for training a student DM using one or more of the disclosed ƒ-distill processes. For the training, the objective is to minimize the discrepancy between the teacher and the student distributions. The gradient algorithm is evaluated and its output is used to determine updates to the parameters of the student DM, e.g., to bring the student DM closer to the teacher DM. In the gradient algorithm, the student-generated distribution is q, and the teacher distribution is p. The gradient algorithm is the gradient of an ƒ-divergence model. Different noise can be input into the student, and a sample corresponding to each of the different types of noise can be generated in, for example, in parallel (or at least partially in parallel). Though a cat is shown in this example, the teacher can be trained using a data set of multiple different types of text-image pairs. In this example, the teacher DM and the student DM are text-to-image models, where the method of training can apply to other modalities and content types depending on the modality of the teacher.

ƒ-distill model 100 has a noise sample 110 fed into a student DM 115 along with an input prompt. Noise sample 110 can be random, fixed, or sourced from a data store or library. Student DM 115 can generate an output content 120. Random noise, fixed noise, or noise sourced from a data store or library can be applied for the diffusion of the student-generated output content. This process can allow training the student DM on multiple noisy levels or systems. The applied noise can improve the use of the knowledge of the teacher DM. The applied noise generates a modified content 125.

A teacher DM 130 receives the modified content and generates an output score based on the teacher distribution of data values. The teacher scores and the student scores can be fed into a gradient algorithm 140 to determine a score difference and a divergence threshold. Gradient algorithm 140 has a weighting function 145 and a fake score 150 components. Fake score 150 is an optional component that can help prevent mode collapse. Gradient algorithm 140 is specified in more detail in Equation 3, which is a gradient of the ƒ-divergence between pₜ and qₜ, and Equation 4, which demonstrates an objective function for the gradient algorithm.

FIG. 2 is an illustration of a diagram of an example charts 200 showing score differences and the weighting function using two-dimensional (2D) plots. Charts 200 has a teacher score plot 210, a student fake score plot 215, a score difference plot 220, and a weighted parameter plot 225. For this example, h is the weighting function using a forward-KL divergence model. Teacher score plot 210 and fake score plot 215 often diverge in lower-density regions where larger estimation errors occur. Darker shades in score difference plot 220 indicate larger score differences. The weighting function can down-weight these regions (shown as lighter shades in weighted parameter plot 225) during gradient updates for the ƒ-distill model.

FIG. 3 is an illustration of a diagram of an example table 300 comparing ƒ-divergence models. Table 300 shows a demonstration of a comparison of different ƒ-divergence models as a function of the likelihood ratio r:=p(x)/q(x). These include the forward-KL divergence, reverse-KL divergence, Hellinger distance, and Jensen-Shannon (JS) divergence. Divergences with a stronger tendency towards mode-seeking can exhibit a slower rate of increase in their weighting function h(r) as r→∞. This behavior stems from the fact that ƒ″(r)=h(r)/r² also increases more slowly, thus tolerating larger density ratios p/q (i.e., allowing q to disregard some modes in p), ultimately leading to mode-seeking behavior.

FIG. 4 is an illustration of a diagram of an example table 400 comparing right and left tail weightings. Table 4 demonstrates right and left tail weights for different ƒ-divergences. In some aspects, the tail weight can be shifted by a constant, such as to improve clarity.

FIG. 5 is an illustration of a diagram of example charts 500 demonstrating a weighting function with mode-seeking divergence. Charts 500 demonstrate an illustration of how a weighting function h 510 (dotted line) in less mode-seeking divergences (for example, forward-KL 520, h=p/q) helps to learn the true data distribution p, compared to more mode-seeking divergences (for example, reverse-KL 525, h=1). Using a less mode-seeking divergence can better capture different modes, from a skewed initial generative distribution q, with the help of the weighting function.

FIG. 6 is an illustration of a diagram of an example inferencing system 600 using a trained student diffusion model according to the principles of the disclosure. The disclosed ƒ-distill processes can be used to train a student DM 610. Student DM 610 can receive an input prompt and then be used to generate output content, such as an image, images, frames of a video, audio, or other content. Student DM 610 can be trained using a gradient algorithm to compare a scored output from Student DM 610 and a scored output from a teacher DM.

FIG. 7 is an illustration of a flow diagram of an example method 700 for implementing the disclosed ƒ-distill model processes. Method 700 can be performed on a computing system, for example, ƒ-distill system 800 of FIG. 8 or ƒ-distill controller 900 of FIG. 9. The computing system can be one or more processors in various combinations (e.g., CPUs, GPUs, SIMDs, or other types of processors), a data center, a cloud environment, a server, a laptop, a mobile device, a smartphone, a PDA, or other computing system capable of receiving the thread requests, and capable of executing threads in parallel. Method 700 can be encapsulated in software code or hardware, for example, an application, code library, code module, dynamic link library, module, function, RAM, ROM module, and other software and hardware implementations. The software can be stored in a file, database, or other computing system storage mechanism. Method 700 can be partially implemented in software and partially in hardware. Method 700 can perform the steps for the described processes, for example, using a text prompt to train a student DM using a gradient algorithm, comparing a student score to a teacher score.

Method 700 starts at a step 705 and proceeds to a step 710. In step 710, input parameters can be received. The input parameters can include an input prompt. In some aspects, the input prompt can be text, an audio portion, an image, a video, a reference to other objects, or other types of prompts. In some aspects, the input parameters can include an ƒ-divergence model to utilize. In some aspects, the input parameters can specify a teacher DM to utilize. In some aspects, the input parameters can specify a weighting function or weighting parameters to utilize. In some aspects, the input parameters can include thresholds, such as a divergence threshold or a score difference threshold. In some aspects, the input parameters can include parameters to adjust the operational parameters of the ƒ-distill model processes.

In a step 715, the training process iteration loop can begin. The iteration loop can have one or more of the following steps in various combinations. In a step 720, the output content can be generated using the student DM and the input prompt. In a step 725, the output content can be logically separated into a set of regions. A student DM score can be determined for each region in the set of regions. The student score can represent a student distribution of data values within each respective region.

In a step 730, the output content can be diffused with noise. In some aspects, the noise can be randomly generated or randomly applied. The diffused output content can be provided to the teacher DM, thereby allowing the teacher DM to analyze the output content. In a step 735, a teacher score of the diffused output content can be generated, corresponding to each region in the set of regions. The teacher score can represent a teacher distribution of data values for the respective region.

In a step 740, a gradient algorithm can be applied to the student scores and the teacher scores. The gradient algorithm can determine a score difference between the student scores and the teacher scores for each region. The gradient algorithm can weight the sore difference within each region separately from other regions. The weighting function can utilize the density ratio of the teacher distribution compared to the student distribution for that region. The weighting function can utilize a time-dependent integral of the score difference. The gradient algorithm can utilize a product of the weighting function and the score difference to determine the gradient algorithm outcome for each region. The gradient algorithm can apply a normalization algorithm to down-weight the weighting output for a region in the set of regions when a score difference threshold is satisfied by the score difference for that region.

In a decision step 745, the outcome of the gradient algorithm (which is a weighted score difference) can be compared to a divergence threshold. If the divergence threshold is satisfied, then method 700 can proceed to a step 795. If the divergence threshold is not satisfied, then method 700 proceeds to step 715. The divergence threshold verifies whether the student DM and the teacher DM produce scores that are close enough for the model to proceed with the training.

In a step 795, remaining updates to the student DM can be made according to the gradient algorithm. The updated student DM can be communicated to a data store, a library, or other computing storage system, or the updates student DM can be used to generate content using other received input prompts. Method 700 ends at step 795.

FIG. 8 is an illustration of a block diagram of an example ƒ-distill system 800. ƒ-distill system 800 can be implemented in one or more computing systems or one or more processors. In some aspects, ƒ-distill system 800 can be implemented using an ƒ-distill model controller, such as ƒ-distill controller 900 of FIG. 9. ƒ-distill system 800 can implement one or more aspects of this disclosure, such as method 700 of FIG. 7.

ƒ-distill system 800, or a portion thereof, can be implemented as an application, a code library, a dynamic link library, a function, a module, a header file, other software implementations, or combinations thereof. In some aspects, ƒ-distill system 800 can be implemented in hardware, such as a ROM, a graphics processing unit, or other hardware implementations. In some aspects, ƒ-distill system 800 can be implemented partially as a software application and partially as a hardware implementation. ƒ-distill system 800 is a functional view of the disclosed processes, and an implementation can combine or separate the functions in one or more software or hardware systems.

ƒ-distill system 800 includes a data transceiver 810, an ƒ-distill processor 820, and a result transceiver 830. The output, e.g., the trained student DM, can be communicated to a data receiver as a result, such as to one or more of a processing system 860 (one or more combinations of processors, or processing cores), one or more users or systems 862, or one or more storage devices 864. The output can be used to understand the capabilities and limitations of each evaluated VLM.

In some aspects, the results of ƒ-distill processor 820, such as those communicated to one or more of processing system 860, one or more storage devices 864, or one or more users or systems 862, can be used as input into another process or system, such as a machine learning system. The results can be used for further processing, such as for input into artificial intelligence learning, for validation of other system processes, or real-world applications.

Data transceiver 810 can receive the input parameters. The input parameters can include algorithms to use, the ƒ-divergence model to use, various threshold parameters, and other operational parameters. The input parameters can include an input prompt describing the request or action. In some aspects, data transceiver 810 can be part of ƒ-distill processor 820.

Result transceiver 830 (e.g., a transmitter) can communicate one or more outputs (e.g., results), to one or more data receivers, such as processing system 860, one or more users or systems 862, storage devices 864, or other related systems, whether proximate result transceiver 830 or distant from result transceiver 830. Data transceiver 810, ƒ-distill processor 820, and result transceiver 830 can be, or can include, conventional interfaces configured for transmitting and receiving data. Data transceiver 810, ƒ-distill processor 820, or result transceiver 830 can be implemented as software components, for example, a virtual processor environment, as hardware, for example, circuits of an integrated circuit, or combinations of software and hardware components and functionality. The functionality described for these components remains intact regardless of how the functionality is implemented.

ƒ-distill processor 820 (e.g., one or more processors such as processor 930 of FIG. 9) can implement the analysis and algorithms as described herein, utilizing the input parameters. ƒ-distill processor 820 can execute code to implement an ƒ-distill model process to train a student DM using a teacher DM. In some aspects, ƒ-distill processor 820 can be a machine learning system. In some aspects, ƒ-distill processor 820 can be a DM scorer configured to assign a score to one or more regions of the output content for a student DM and a teacher DM.

ƒ-distill processor 820 can be one or more of a multicore processor, a multiprocessor system, or a streaming multiprocessor. ƒ-distill processor 820 can be implemented by a central processor unit (CPU), a graphics processor unit (GPU), or other types of processors. ƒ-distill processor 820 can be a non-transitory computer program product having a series of operating instructions stored on a non-transitory computer-readable medium that directs an ƒ-distill model processing apparatus, when executed thereby to perform operations as disclosed herein.

A memory or data storage system of ƒ-distill processor 820 (such as a core cache, L1 cache, L2 cache, or other memory systems) can be configured to store the processes and algorithms for directing the operation of ƒ-distill processor 820. ƒ-distill processor 820 can include a processor that can be configured to operate according to the analysis operations and algorithms disclosed herein, and an interface to communicate (transmit and receive) data.

FIG. 9 is an illustration of a block diagram of an example of a ƒ-distill controller 900 according to the principles of the disclosure. ƒ-distill controller 900 can be stored on one computer or multiple computers. The various components of ƒ-distill controller 900 can communicate via wireless or wired conventional connections. A portion or a whole of ƒ-distill controller 900 can be located at one or more locations. In some aspects, ƒ-distill controller 900 can be part of another system (e.g., processor, core, server, or other systems), and can be integrated with one device, such as a part of a processing system. ƒ-distill controller 900 represents a demonstration of the functionality employed for the disclosure, and implementations can use a variety of devices, for example, circuits of a processor, dedicated processors, virtual systems, servers, other computing or processing systems, in software or hardware, or various combinations thereof.

ƒ-distill controller 900 can be configured to perform the various functions disclosed herein, including receiving input parameters, input prompts, and DMs, and generating results (e.g., DM scores, gradient responses used by the student DM) from the execution of the methods and processes described herein, such as determining new parameters for the student DM from results of a gradient algorithm. ƒ-distill controller 900 includes a communications interface 910, a memory 920, and a processor 930.

Communications interface 910 can be configured to transmit and receive data. For example, communications interface 910 can receive the input parameters, including the input prompt, the DMs, and threshold parameters. Communications interface 910 can transmit the output or interim outputs. In some aspects, communications interface 910 can transmit a status, such as a success or failure indicator of ƒ-distill controller 900 regarding receiving the various inputs, transmitting the output contents, or producing the results.

In some aspects, processor 930 can perform the operations as described by ƒ-distill processor 820. Communications interface 910 can communicate via the communication systems used in the industry. For example, wireless or wired protocols can be used. Communication interface 910 can perform the operations as described for data transceiver 810 and result transceiver 830 of FIG. 8.

Memory 920 can be configured to store a series of operating instructions that direct the operation of processor 930 when initiated, including supporting code representing the algorithm for performing a ƒ-distill process for training a student DM. Memory 920 can be a non-transitory computer-readable medium. Multiple types of memory can be used for the data storage systems, and memory 920 can be distributed.

Processor 930 can be one or more processors. Processor 930 can be a combination of processor types, such as a CPU, a GPU, a single instruction multiple data (SIMD) processor, or other processor types. Processor 930 can be configured to produce the output, one or more interim outputs, and statuses utilizing the received inputs. Processor 930 can determine the output using parallel processing. Processor 930 can be an integrated circuit. In some aspects, processor 930, communications interface 910, memory 920, or various combinations thereof, can be an integrated circuit. Processor 930 can be configured to direct the operation of ƒ-distill controller 900. Processor 930 includes the logic to communicate with communications interface 910 and memory 920, and performs the functions described herein. Processor 930 can be capable of performing or directing the operations as described by ƒ-distill processor 820 of FIG. 8. For example, in some aspects, ƒ-distill system 800 or ƒ-distill controller 900 can systematically train a student DM using a teacher DM and a gradient algorithm.

In some aspects, ƒ-distill system 800 or ƒ-distill controller 900 can be part of another system that receives the input parameters. For example, in some aspects, ƒ-distill system 800 or ƒ-distill controller 900 can be part of a machine learning system, an AI generative tool, or can be in a data center, a cloud system, an edge system, a corporate system, or other type of system or location. In some aspects, ƒ-distill system 800 or ƒ-distill controller 900 can be part of a machine learning system, where ƒ-distill processor 820 can be part of the machine learning processes. In some aspects, ƒ-distill system 800 or ƒ-distill controller 900 can implement a non-transitory computer program product having a series of operating instructions stored on a non-transitory computer-readable medium that directs a data processing apparatus, when executed thereby to perform operations, the operations comprising the steps described herein for this disclosure, such as method 700 of FIG. 7.

A portion of the above-described apparatus, systems, or methods can be embodied in or performed by various digital data processors or computers, wherein the computers are programmed or store executable programs of sequences of software instructions to perform one or more of the steps of the methods. The software instructions of such programs can represent algorithms and be encoded in machine-executable form on non-transitory digital data storage media, e.g., magnetic or optical disks, random-access memory (RAM), magnetic hard disks, flash memories, or read-only memory (ROM), to enable various types of digital data processors or computers to perform one, multiple or all of the steps of one or more of the above-described methods, or functions, systems or apparatuses described herein. The data storage media can be part of or associated with digital data processors or computers.

The digital data processors or computers can be comprised of one or more GPUs, one or more CPUs, one or more of other processor types, or a combination thereof. The digital data processors and computers can be located proximate to each other, proximate to a user, in a cloud environment, a data center, or located in a combination thereof. For example, some components can be located proximate to the user, and some components can be located in a cloud environment or data center.

The GPUs can be embodied on one semiconductor substrate, included in a system with one or more other devices such as additional GPUs, a memory, and a CPU. The GPUs can be included on a graphics card that includes one or more memory devices and is configured to interface with the motherboard of a computer. The GPUs can be integrated GPUs (iGPUs) that are co-located with a CPU on one chip. Configured or configured to means, for example, designed, constructed, or programmed, with the necessary logic or features for performing a task or tasks. The processors or computers can be part of GPU racks located in a data center. The GPU racks can be high-density (HD) GPU racks that include high-performance GPU compute nodes and storage nodes. The high-performance GPU compute nodes can be servers designed for general-purpose computing on graphics processing units (GPGPU) to accelerate deep learning applications. For example, the GPU compute nodes can be servers of the DGX product line from NVIDIA Corporation of Santa Clara, California.

The compute density provided by the HD GPU racks is advantageous for AI computing and GPU data centers directed to AI computing. The HD GPU racks can be used with reactive machines, autonomous machines, self-aware machines, and self-learning machines that use a large compute-intensive server infrastructure. For example, the GPU data centers employing HD GPU racks can provide the storage and networking needed to support large-scale neural network (NN) training, such as for the NNs disclosed herein used for neural motion planners. The NNs can be Deep Neural Networks (DNN).

The NNs disclosed herein include multiple layers of connected nodes that can be trained with input data to solve complex problems. For example, contextual data, UPC, proposed trajectories, or a combination thereof can be used as input data for training of the NN. Once the NNs are trained, the NNs can be deployed and used to generate planned trajectories.

In one example of training, data flows through the NNs in a forward propagation phase until a prediction is produced that indicates a label corresponding to the input. When the NNs do not correctly label the input, errors between the correct label and the predicted label are analyzed, and the weights are adjusted for features of the layers during a backward propagation phase that correctly labels the inputs in a training dataset. With thousands of processing cores that are optimized for matrix math operations, GPUs such as those noted above are capable of delivering the performance for training NNs for artificial intelligence and machine learning applications.

Portions of disclosed examples or embodiments can relate to computer storage products with a non-transitory computer-readable medium that have program code thereon for performing various computer-implemented operations that embody a part of an apparatus, device, or carry out the steps of a method set forth herein. Non-transitory used herein refers to all computer-readable media except for transitory, propagating signals. Examples of non-transitory computer-readable media include but are not limited to: magnetic media such as hard disks, floppy disks, and magnetic tape; optical media such as CD-ROM disks; magneto-optical media such as floppy disks; and hardware devices that are specially configured to store and execute program code, such as ROM and RAM devices. Configured or configured to means, for example, designed, constructed, or programmed, with the necessary logic or features for performing a task or tasks. Examples of program code include machine code, such as produced by a compiler, and files containing higher-level code that can be executed by the computer using an interpreter.

In interpreting the disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps can be present, utilized, or combined with other elements, components, or steps that are not expressly referenced.

Those skilled in the art to which this application relates will appreciate that other and further additions, deletions, substitutions, and modifications can be made to the described embodiments. It is also to be understood that the terminology used herein is to describe particular embodiments only, and is not intended to be limiting, since the scope of the present disclosure will be limited only by the claims. Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, a limited number of the exemplary methods and materials are described herein.

Various aspects of the disclosure can be claimed, such as the apparatuses, systems, and methods disclosed herein. Below are claims that can correspond to the different aspects. Each of the example independent claims can have one or more of the additional features of the below dependent claims in combination.

What is claimed is:

1. A method of training a student diffusion model (DM) using a trained teacher DM, comprising:
receiving an input prompt directing the generation of an output content;
iterating a training process, comprising:
generating the output content using the input prompt, using the student DM;
determining a set of regions of the output content, and a student score for each region in the set of regions representing a student distribution for each region;
diffusing the output content using random noise to generate a diffused output content;
providing the diffused output content to the teacher DM;
generating a teacher score of the diffused output content, for each region in the set of regions, representing a teacher distribution for each region;
updating region parameters of the student DM according to a gradient algorithm, wherein the gradient algorithm is a product of a score difference of the teacher score and the student score for each respective region, and a weighting output for the respective region; and
repeating the iterating until a score distance between the student score and the teacher score satisfies a divergence threshold for each region in the set of regions; and
updating the student DM with the region parameters for each region in the set of regions.

2. The method as recited in claim 1, further comprising:
matching the student distribution of data values generated by the student DM to the teacher distribution imposed by the teacher DM, wherein the matching uses the gradient algorithm.

3. The method as recited in claim 1, wherein output content is an image, a frame of video, a series of frames of video, or an audio portion.

4. The method as recited in claim 3, wherein multiple output contents are generated in parallel by the student DM using a different noise parameter.

5. The method as recited in claim 1, wherein the weighting output is a variable weighting, and dependent on a density ratio and a selected ƒ-divergence model.

6. The method as recited in claim 1, wherein the density ratio is obtained from a discriminator objective.

7. The method as recited in claim 6, wherein the discriminator objective is a generative adversarial network (GAN).

8. The method as recited in claim 1, wherein the gradient algorithm uses a normalization algorithm.

9. The method as recited in claim 8, wherein the normalization algorithm down-weights the weighting output in a region in the set of regions of the output content where the teacher DM has a low density of data values.

10. The method as recited in claim 8, wherein the normalization algorithm down-weights the weighting output for a region in the set of regions of the output content when a score difference threshold is satisfied by the score difference for the region.

11. The method as recited in claim 8, wherein the normalization algorithm normalizes a time-dependent density ratio using a time range that is discretized into one or more bins, wherein values within each bin of the one or more bins is normalized by their respective averages.

12. The method as recited in claim 11, wherein the normalization algorithm normalizes the weighting output by an average value within each bin of the one or more bins.

13. The method as recited in claim 1, wherein the weighting output is modified by a time-dependent factor.

14. The method as recited in claim 1, wherein the teacher score is determined using a single step generator through variational score distillation, and the gradient algorithm directly maps a noise parameter from the output content to the diffused output content.

15. The method as recited in claim 1, wherein the gradient algorithm uses the score difference for each respective region to incorporate more than one high-density point of the teacher distribution.

16. The method as recited in claim 1, wherein the student score is estimated using a fake score network of the student distribution, and the gradient algorithm alternates between a generated student score and a fake student score.

17. The method as recited in claim 1, wherein the student DM is initialized with pre-trained diffusion models.

18. A non-transitory computer-readable medium having a series of operating instructions stored thereon that directs a data processing apparatus when executed thereby to perform operations, the operations comprising:
receiving an input prompt directing the generation of an output content;
iterating a training process, comprising:
generating the output content using the input prompt, using the student DM;
determining a set of regions of the output content, and a student score for each region in the set of regions representing a student distribution for each region;
diffusing the output content using random noise to generate a diffused output content;
providing the diffused output content to the teacher DM;
generating a teacher score of the diffused output content, for each region in the set of regions, representing a teacher distribution for each region;
updating region parameters of the student DM according to a gradient algorithm, wherein the gradient algorithm is a product of a score difference of the teacher score and the student score for each respective region, and a weighting output for the respective region; and
repeating the iterating until a score distance between the student score and the teacher score satisfies a divergence threshold for each region in the set of regions; and
updating the student DM with the region parameters for each region in the set of regions.

19. The non-transitory computer-readable medium as recited in claim 18, wherein the student DM is communicated to a data store or used by a system as an input parameter.

20. An ƒ-divergence system, comprising:
a student diffusion model (DM) configured to generate, in a single step, an output content from an input prompt, and a student score for each region of the output content representing a student distribution of data within each respective region;
a teacher DM configured to generate a teacher score for each respective region of the output content;
an ƒ-distill processor configured to diffuse, with random noise, the output content prior to the teacher DM generating the teacher score, evaluate a gradient algorithm for each region of the output content, and update the student DM with the results of the gradient algorithm, wherein the gradient algorithm is as product of a score difference and a weighting parameter, the score difference is a difference, for each region, between the student score and the teacher score, and repeat the diffuse, evaluate, and update until the score difference satisfies a divergence threshold for each region of the output content.

21. The ƒ-divergence system as recited in claim 20, wherein the ƒ-distill processor is further configured to normalize the weighting parameter for a region using one or more the teacher DM having low density of data values, a score difference threshold is satisfied, or a time-dependent density ratio using discretized time bins, and to incorporate a fake student score to prevent mode collapse.

22. A system, comprising:
a receiver configured to receive input parameters, wherein the input parameters include at least an input prompt, a divergence threshold, a score threshold, and a specified ƒ-divergence model; and
one or more processors, configured to execute code to iterate a training process for a student diffusion model (DM), wherein the training process includes at least generating a output content using the input prompt by using the student DM, determining a set of regions of the output content, and a student score for each region in the set of regions representing a student distribution for each region, diffusing the output content using random noise to generate a diffused output content, providing the diffused output content to the teacher DM, generating a teacher score of the diffused output content, for each region in the set of regions, representing a teacher distribution for each region, updating region parameters of the student DM according to a gradient algorithm, wherein the gradient algorithm is a product of a score difference of the teacher score and the student score for each respective region, and a weighting output for the respective region, and repeating the iterating until a score distance between the student score and the teacher score satisfies a divergence threshold for each region in the set of regions.

23. The system as recited in claim 22, wherein the one or more processors is a machine learning system.

24. The system as recited in claim 23, wherein the machine learning system includes the receiver.

25. The system as recited in claim 22, wherein the one or more processors is one or more of a central processor unit (CPU) or a graphics processor unit (GPU).
